(19) United States
(12) Patent Application Publication
(10) Pub. No.: US 2009/0228735 A1
(43) Pub. Date: Sep. 10, 2009

(54) INFORMATION PROCESSING APPARATUS AND ELAPSED TIME MEASURING METHOD

(75) Inventors: Seiji IKEDA, Osaka (JP); Yoichi AYABE, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/396,708

(22) Filed: Mar. 3, 2009

(30) Foreign Application Priority Data
Mar. 7, 2008 (JP) 2008-057444

(51) Int. Cl. G06F 1/14

(52) U.S. Cl. 713/502; 714/55; 713/2

(57) ABSTRACT

In an information processing apparatus and elapsed time measuring method of the present invention, a microcomputer for power supply control measures an elapsed time when the product is in an operating condition, a time when the product is powered off is read from an RTC in a system LSI and written to a storage unit in a BIOS, a time when the product is next powered on is read from the RTC, and a difference between the two times is calculated in order to obtain an elapsed time for when the product is in a non-operating condition. An elapsed time of the product is calculated by adding together two types of elapsed times in the BIOS. This structure enables providing an information processing apparatus and elapsed time measuring method that can accurately measure the elapsed time of the product without being influenced by a user operation.

### BACKGROUND OF THE INVENTION

1. Field of the Invention

The present invention relates to an elapsed time measuring method able to measure the elapsed time from a product manufacturing date in a personal computer and the like. The present invention also relates to an information processing apparatus able to perform the elapsed time measuring method.

2. Description of Related Art

In a personal computer (hereinafter, called a “PC”), when the total operating time reaches a certain time period, or when a certain time period (number of years) since the manufacturing date has elapsed, there are cases in which failures occur, such as various parts such as the hard disk failing easily. There is a limit to the number of years that PC manufacturers store repair parts. If there is a desire to replace a failed part with a new part (repair part), there are cases in which, if the timing of the failure is after the passing of the number of years that repair parts are stored, the repair part is no longer in the manufacturer's stock, and repair cannot be performed. In order to solve such a problem, there is a desire to issue a warning to the user when the usage time of a PC has reached a certain time period. However, measuring the usage time (the elapsed time since the manufacturing date) has not been possible in conventional PCs accurately.

As methods for measuring elapsed time when the PC is during a certain condition, there is a method of calculating the elapsed time when the PC is in an operating condition with use of a system timer included in a microcomputer in the PC. Also a method of adding up the elapsed time with use of time information output by a real-time clock (hereinafter, called an “RTC)) included in a system LSI in the PC (e.g., see JP 2005-70968A) has been proposed.

However, the elapsed time measuring method using the system timer of the microcomputer only can measure the elapsed time when the PC is in the operating condition (condition in which the power supply is ON), which is a problem.

In the elapsed time measuring method using current time information output from the RTC included in the system LSI, even when the PC is in a non-operating condition (condition in which the power supply is OFF), the current time information can be known since the RTC operates on a backup power source. However, since a user easily can operate the PC to modify the current time information output from the RTC, an accurate elapsed time cannot be calculated, which is a problem.

### SUMMARY OF THE INVENTION

An object of the present invention is to provide an information processing apparatus and elapsed time measuring method that can measure an elapsed time in a product accurately without being influenced by a user operation.

An information processing apparatus of the present invention includes: a main timing unit able to measure an elapsed time during an operating period of the apparatus; a sub timing unit able to measure an elapsed time during at least a non-operating period of the apparatus; and a calculation unit that adds together the elapsed time measured by the main timing unit and the elapsed time measured by the sub timing unit. The calculation unit adds together each elapsed time measured by the main timing unit when the apparatus is during the operating period, adds together each elapsed time measured by the sub timing unit when the apparatus is during the non-operating period, and calculates a cumulative elapsed time since a given date/time based on the added elapsed times.

An elapsed time measuring method in an information processing apparatus of the present invention includes: a main timing step of measuring an elapsed time during an operating period of an information processing apparatus; an auxiliary timing step of measuring an elapsed time during at least a non-operating period of the information processing apparatus; and a calculating step of adding together the elapsed time measured in the main timing step and the elapsed time measured in the auxiliary timing step. The operating time information that is an elapsed time from a start of operation to an end of operation is obtained in the main timing step, operation end time information is obtained in the auxiliary timing step when operation of the information processing apparatus ends, operation start time information is obtained in the auxiliary timing step when operation of the information processing apparatus starts, non-operating time information is generated based on a difference between the operation start time information and the operation end time information, and a cumulative elapsed time from a given date/time is calculated by adding together the operating time information and the non-operating time information.

The present invention enables providing an information processing apparatus and elapsed time measuring method that can measure an elapsed time in a product accurately without being influenced by a user operation.

### BRIEF DESCRIPTION OF THE DRAWINGS

FIG. 1 is a block diagram of an information processing apparatus according to an embodiment of the present invention.

FIG. 2 is a time chart for describing an elapsed time measuring method according to the embodiment of the present invention.

FIG. 3 is a flowchart for describing the elapsed time measuring method according to the embodiment of the present invention.

FIG. 4 is a block diagram showing an example of another structure of the information processing apparatus according to the embodiment.

FIG. 5 is a block diagram showing an example of yet another structure of the information processing apparatus according to the embodiment.

### DETAILED DESCRIPTION OF THE INVENTION

An information processing apparatus of the present invention includes: a main timing unit able to measure an elapsed time during an operating period of the apparatus; an sub timing unit able to measure an elapsed time during at least a non-operating period of the apparatus; and a calculation unit that adds together the elapsed time measured by the main timing unit and the elapsed time measured by the sub timing unit, wherein the calculation unit adds together each elapsed time measured by the main timing unit when the apparatus is during the operating period, adds together each elapsed time measured by the sub timing unit when the apparatus is during the non-operating period, and calculates a cumulative elapsed time since a given date/time based on the added elapsed times. This structure enables accurately measuring the elapsed time in both an operating condition and a non-operating condition of the information processing apparatus without being influenced by, for example, a time modification performed by a user.

The information processing apparatus of the present invention can have various forms such as the following, based on the above-described structure.

In other words, in the information processing apparatus of the present invention, the calculation unit may obtain operation end time information pertaining to the apparatus from the sub timing unit, obtain operation start time information pertaining to the apparatus from the sub timing unit, and calculate non-operating time information based on a difference between the operation end time information and the operation start time information, and the calculation unit may calculate the cumulative elapsed time since the given date/time by adding together operating time information pertaining to the apparatus that has been output from the main timing unit and the non-operating time information. This structure enables accurately measuring the elapsed time in both the operating condition and non-operating condition of the information processing apparatus without being influenced by, for example, a time modification performed by the user.

In the information processing apparatus of the present invention, the calculation unit may compare the cumulative elapsed time and a given time that has been set in advance, and alert processing may be performed if a result of the comparison is that the cumulative elapsed time has exceeded the given time. This system enables making a preliminary announcement regarding a need for maintenance due to the elapse of time in the information processing apparatus, such as a preliminary announcement regarding a hard disk failure or a preliminary announcement regarding a repair.

The information processing apparatus of the present invention may include: a microcomputer able to measure an elapsed time during an operating period of the apparatus; a system LSI including a real-time clock able to measure an elapsed time during at least a non-operating period of the apparatus; and a BIOS that adds together the elapsed time measured by the microcomputer and the elapsed time measured by the real-time clock, wherein the BIOS adds together each elapsed time measured by the microcomputer when the apparatus is during the operating period, adds together each elapsed time measured by the real-time clock when the apparatus is during the non-operating period, and calculates a cumulative elapsed time from a given date/time based on the added elapsed times. This structure enables accurately measuring a product elapsed time in a normal PC that does not include special hardware or software.

An elapsed time measuring method in an information processing apparatus of the present invention includes: a main timing step of measuring an elapsed time during an operating period of an information processing apparatus; an auxiliary timing step of measuring an elapsed time during at least a non-operating period of the information processing apparatus; and a calculating step of adding together the elapsed time measured in the main timing step and the elapsed time measured in the auxiliary timing step. The operating time information that is an elapsed time from a start of operation to an end of operation is obtained in the main timing step, operation end time information is obtained in the auxiliary timing step when operation of the information processing apparatus ends, operation start time information is obtained in the auxiliary timing step when operation of the information processing apparatus starts, non-operating time information is generated based on a difference between the operation start time information and the operation end time information, and a cumulative elapsed time since a given date/time is calculated by adding together the operating time information and the non-operating time information.

In the elapsed time measuring method of the present invention, the cumulative elapsed time and a given time that has been set in advance may be compared, and alert processing may be performed if a result of the comparison is that the cumulative elapsed time has exceeded the given time. This method enables making a preliminary announcement regarding a need for maintenance due to the elapse of time in the information processing apparatus, such as a preliminary announcement regarding a hard disk failure or a preliminary announcement regarding a repair.

### Embodiment

### 1. Information Processing Apparatus Structure

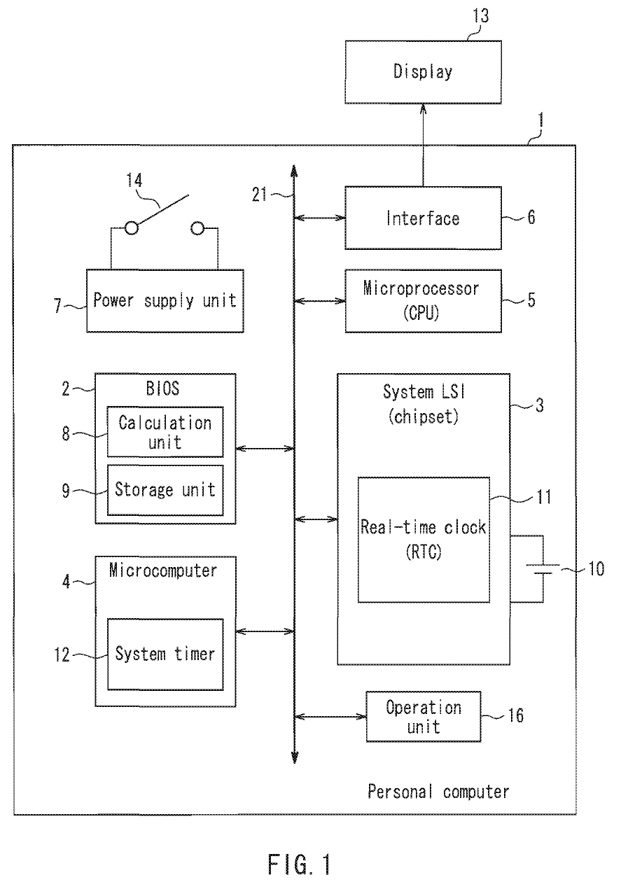

FIG. 1 is a block diagram of an information processing apparatus according to the embodiment of the present invention.

In the following description, “operating period” refers to a period in which the power of a PC is ON. Here, “operating condition” refers to a condition in which the power of a PC 1 is ON. Also, “non-operating period” refers to a period in which the power of a PC is OFF. Here, “non-operating condition” refers to a condition in which the power of the PC 1 is OFF.

The PC 1 shown in FIG. 1 is an example of an information processing apparatus. The PC 1 includes a BIOS 2 (Basic Input Output System), a system LSI 3, a microcomputer 4, a microprocessor 5, an interface 6, an operation unit 16, and a power supply unit 7 that supplies power to the above constituent elements. Note that the BIOS 2, system LSI 3, microcomputer 4, microprocessor 5, interface 6, and operation unit 16 are connected to a system bus 21 and can perform communication of information with each other.

The BIOS 2 is constituted from a flash memory that includes an area (calculation unit 8) storing a program for performing calculation processing and an area (storage unit 9) to which and from which data arbitrarily can be written and read. The calculation unit 8 can calculate a cumulative elapsed time based on an elapsed time measured by an RTC 11, an elapsed time measured by a system timer 12, and operation start times and operation end times of the PC 1. Note that details of the method for calculating the cumulative elapsed time are described later. Since the BIOS 2 is constituted from a flash memory, storage content is held in the storage unit 9 even when the PC 1 is during the non-operating period. The storage unit 9 can store the elapsed time measured by the RTC 11, the elapsed time measured by the system timer 12, the operation start times and operation end times of the PC 1, the cumulative elapsed time, and the like. Note that instead of being limited to a flash memory, the BIOS 2 can be realized by a compound chip including a ROM (Read Only Memory) storing the program for performing calculation processing and a flash memory to which and from which data can be written and read arbitrarily.

The system LSI 3 is a part normally called a “chipset”, and includes the real-time clock (hereinafter, called an “RTC”) 11. The system LSI 3 is connected to a backup battery 10 and receives a supply of power even when the PC 1 is during the non-operating period. The backup battery 10 can be constituted as a button-type battery or the like.

The RTC 11 is an integrated circuit that receives a constant supply of power due to the backup battery 10 and can perform a time measuring operation even when the PC 1 is during the non-operating period. Note that the RTC 11 may be incorporated in the system LSI as an integrated circuit, or may be incorporated in the system LSI as software. The RTC 11 includes a crystal oscillator that oscillates at a given frequency due to the application of a voltage, and an oscillation circuit that generates a clock (1 Hz) by pulse division based on the oscillation of the crystal oscillator. The RTC 11 measures the elapsed time by counting the clock output from the oscillation circuit. The oscillating frequency of the crystal oscillator is a frequency that enables easily generating the clock by performing division processing (e.g., 32,768 Hz). The RTC 11 calculates the current time by adding the counted clock value (elapsed time) to a given time. The “given time” is, for example, the manufacturing date/time of the PC 1, the date/time when the power of the PC 1 was first turned on after manufacturing, the date/time when the RTC 11 was reset due to the backup battery 10 being replaced, or a date/time arbitrarily input by a user. When the user performs an operation to modify the current time information when the PC 1 is during the operating period, the current time information calculated by the RTC 11 is changed to the time information input by the user. Accordingly, there are cases in which the current time information generated by the RTC 11 is changed by the user when the PC 1 is during the operating period, and therefore the current time information does not necessarily indicate the correct current time. However, when the PC 1 is in the non-operating condition, changing the current time information and elapsed time information generated by the RTC 11 from the outside is extremely difficult, and therefore the RTC 11 can perform correct measuring. Accordingly, the RTC 11 is suited for performing a measuring operation when the PC 1 is in the non-operating period.

The microcomputer 4 mainly controls operations pertaining to power supply in the PC 1. The microcomputer 4 only operates when the PC 1 is in the operating condition. The microcomputer 4 generates a clock that is a reference for operations of the PC 1. The microcomputer 4 includes the system timer 12. The microcomputer 4 also includes a crystal oscillator that can generate a clock having a constant frequency.

The system timer 12 counts the clock generated by the microcomputer 4 when the PC 1 is in the operating period. The system timer 12 starts measuring (counting the clock output from the crystal oscillator) when the PC 1 starts up, and ends measuring when the PC 1 ends operations. The system timer 12 calculates the current time by adding the counted clock value to the given time information. The system timer 12 can perform the measuring operation continuously when the PC 1 is in the operating period. It is extremely difficult for the measuring operation of the system timer 12 to be stopped by an operation from the outside or the like, or for the current time information and elapsed time information calculated by the measuring operation of the system 12 to be changed arbitrarily. Accordingly, the system timer 12 is suited for performing the measuring operation when the PC 1 is during the operating period.

Here, “making a change from the outside is difficult” refers to a condition in which it is difficult for a common user to make a change using a normal method. A “common user” refers to, for example, a user sufficiently skilled to operate an operating system (OS) installed in the PC 1. A “normal method” refers to a method in which a current time setting program included in the OS is started up, and the current time is modified by operating the operation unit 16.

The microprocessor 5 is an apparatus able to execute various types of program software and the OS installed in the PC 1. The microprocessor 5 can be realized by, for example, 32-bit central processing unit (CPU) or 64-bit central processing unit (CPU). The microprocessor 5 can perform control to generate viewing information based on a processing result and output the generated viewing information to a display 13 via the interface 6.

The interface 6 can be connected to a cable (not shown) having one end that is connected to the display 13. The interface 6 is for outputting the viewing information generated by the microprocessor 5 to the display 13.

The display 13 can display images based on the viewing information sent from the PC 1. The display 13 may be a display apparatus such as a liquid crystal display unit or CRT (Cathode Ray Tube) display unit that is externally connected to the PC 1, or a display apparatus such as a liquid crystal display panel included in the PC 1, as in the exemplary case of a notebook PC.

The operation unit 16 is an input apparatus that receives an input of various user operations. The operation unit 16 includes a keyboard, a mouse, a touchpad, and the like that generally are included in a PC.

In the PC 1, when a certain time period (e.g., several years to ten years) from the manufacturing date/time has elapsed, there are cases of failures such as operation of the hard disk becoming unstable and the RTC no longer operating due to depletion of the backup battery. In such cases, there is a need to replace the failed hard disk drive with a new hard disk drive, or replace the depleted backup battery with a new backup battery. However, the user often becomes aware of such failures when they actually occur during operations, and there are cases in which the failure is already serious when the user becomes aware of it. For example, in the case of a hard disk drive failure, important files recorded on the hard disk already may be corrupted when the failure in operations occurs. Accordingly, with failures in parts such as the hard disk drive and backup battery, it is desirable to alert the user before a failure in operations occurs.

In view of this, the present embodiment has a structure in which the elapsed time since the PC 1 was manufactured is measured, and the user is alerted by issuing a warning or the like when the elapsed time has reached a given time. The following describes a method of measuring the elapsed time.

### 2. Elapsed Time Measuring Method

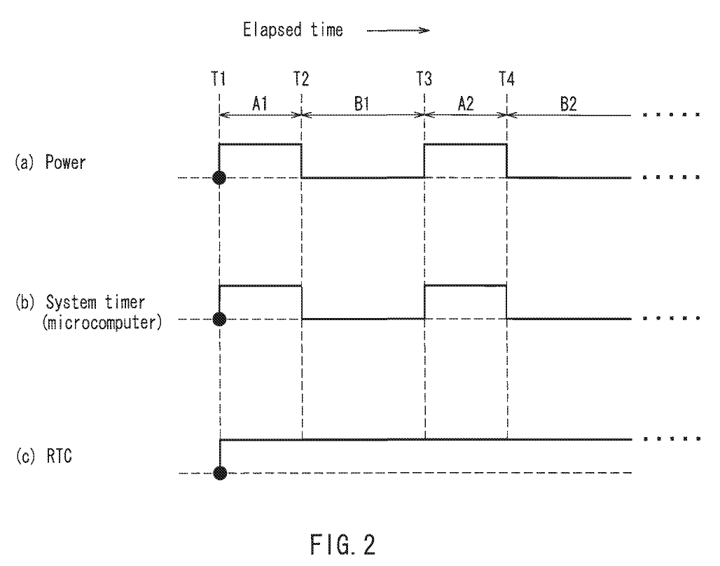

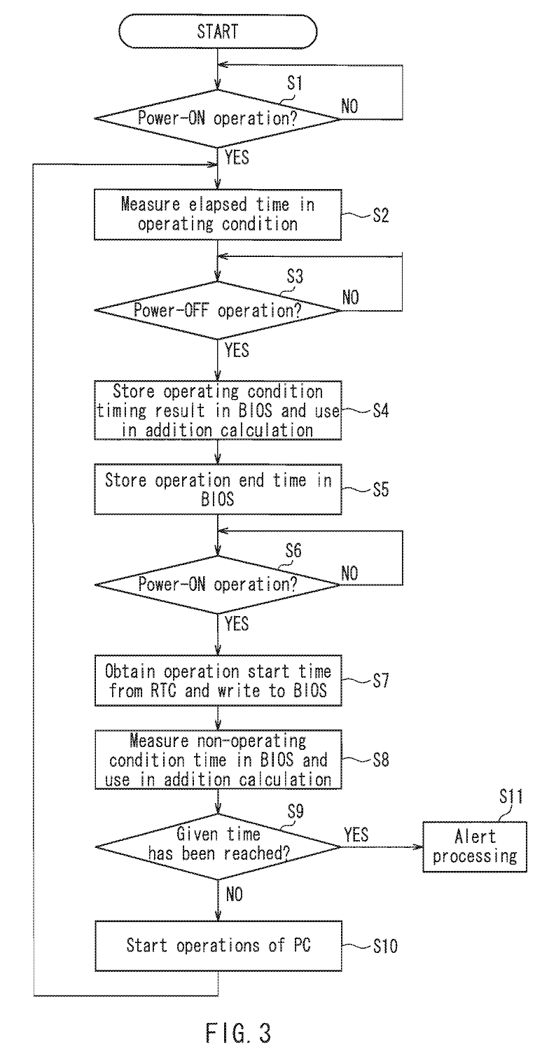

FIG. 2 is a time chart for describing a measuring operation in the elapsed time measuring method according to the embodiment of the present invention. FIG. 2(a) shows a condition of power supply in the PC 1, where a High period is a period in which the power is on and a Low period is a period in which the power is OFF. FIG. 2(b) shows an operating condition of the system timer 12 (microcomputer 4), where a High period is a period in which the measuring operation is being performed and a Low period is a period in which the measuring operation is stopped. FIG. 2(c) shows an operating condition of the RTC 11, where a High period is a period in which the measuring operation is being performed and a Low period is a period in which the measuring operation is stopped. FIG. 3 is a flowchart for describing operations in the elapsed time measuring method according to the embodiment of the present invention.

Firstly, when the PC 1 first is started up after manufacturing by a power switch 14 being operated (time T1 in FIG. 2, YES judgment in processing S1 in FIG. 3), the system timer 12 of the microcomputer 4 starts measuring a PC 1 operating condition elapsed time (hereinafter, called an “operating time”) A1. At the same time, the RTC 11 starts measuring the elapsed time (processing S2). At this time, the system timer 12 can time the operating time A1 accurately since there is no influence from the outside.

Next, when the user inputs a power-OFF instruction by operating the power switch 14, or when the user inputs an instruction to execute a shutdown program in the OS (time T2 in FIG. 2, YES judgment in processing S3 in FIG. 3), the microcomputer 4 sends information pertaining to the operating time A1 measured by the system timer 12 to the system LSI 3. The system LSI 3 performs control to write the information pertaining to the operating time A1 sent by the microcomputer 4 to the storage unit 9 of the BIOS 2 (processing S4).

At the same time, the BIOS 2 requests the RTC 11 to send time information pertaining to time T2 at which the PC 1 was powered off. The RTC 11 sends the time information of T2 to the BIOS 2 in accordance with the request from the BIOS 2. The BIOS 2 writes the time information of T2 sent by the RTC 11 to the storage unit 9 (processing S5). Note that the time information of T2 sent by the RTC 11 remains stored in the storage unit 9 of the BIOS 2 when the PC 1 is in the non-operating condition as well.

Next, when the PC 1 moves to the operating condition due to the user operating the power switch 14 (time T3 in FIG. 2, YES judgment in processing S6 in FIG. 3), the BIOS 2 requests the RTC 11 to send time information pertaining to time T3 at which the PC 1 was powered on. The RTC 11 sends the time information of T3 to the BIOS 2 in accordance with the request from the BIOS 2. The BIOS 2 writes the time information of T3 sent by the RTC 11 to the storage unit 9 (processing S7).

Next, the calculation unit 8 calculating a non-operating condition elapsed time (hereinafter, called a “non-operating time”) B1. That is, the calculation unit 8 performs a difference calculation using the time information of T2 that is stored in the storage unit 9 and was obtained from the RTC 11 when the PC 1 was last powered off and the time information of T3 that was obtained from the RTC 11 when the PC 1 most recently was powered on. Next, the calculation unit 8 calculates a cumulative elapsed time C by adding the calculated non-operating time B1 to the most recent operating time A1. The calculation unit 8 stores the calculated cumulative elapsed time C in the storage unit 9. In other words, the calculation unit 8 performs the following calculation processing (processing S8).

B1=T3−T2

C=A1+B1

The RTC 11 accurately can measure the non-operating time B1 since the current time information cannot be changed by operating the operation unit 16 when the PC 1 is during the non-operating period.

Next, the BIOS 2 compares the cumulative elapsed time C calculated by the calculation unit 8 and a time (e.g., ten years) indicated in given time information stored in the storage unit 9 in advance (processing S9). Note that the “given time information” is time information determined by the manufacturer of the PC 1 at the time of manufacturing, with consideration given to the timing of failures in the hard disk drive and the timing of depletion of the remaining capacity of the backup battery. If the cumulative elapsed time C has not reached the given time (NO judgment in processing S9), the BIOS 2 sends, to the system LSI 3, and instruction to start operations of the PC 1. In accordance with the instruction from the BIOS 2, the system LSI 3 starts startup processing of the PC 1 (processing S10).

Thereafter, similarly to as described above, the system timer 12 starts measuring a PC 1 operating time A2 (processing S2). From time T4 onward, the calculation unit 8 calculates the cumulative elapsed time C(=A1+B1+ . . . +Aj+Bj+ . . . ) based on PC 1 operating times Aj obtained from the system timer 12 and non-operating times Bj obtained from the RTC 11, and stores the calculated cumulative elapsed time C in the storage unit 9.

When the calculation unit 8 has judged that the cumulative elapsed time has reached the given time (YES judgment in processing S9), the BIOS 2 sends the judgment result to the microprocessor 5. The microprocessor 5 generates viewing information based on the instruction from the BIOS 2, and outputs the generated viewing information to the display 13 via the interface 6. The display 13 alerts the user that the cumulative elapsed time C has reached the given time by displaying an image based on the viewing information sent by the microprocessor 5 (processing S11).

The alert processing can be, for example, processing for displaying a warning message such as “The usage period of this computer has reached 10 years. Inspection is required.” on the screen of the display 13. Also, the alert processing can be processing for displaying a warning message such as “The usage period of this computer has reached 10 years. Inspection is required.” on the BIOS startup screen that is displayed on the display 13 before the OS starts up when an operation is performed to power on the PC 1. Note that the above warning message is exemplary.

Note that the warning message may be displayed on the display 13 only when the PC 1 is started up, or may be displayed continuously on the display 13 when the PC 1 is during the operating period. Causing the warning message to be displayed continuously on the display 13 when the PC 1 is during the operating period enables improving the reliability of alerting the user. In other words, if the warning message only is displayed when the PC 1 is started up, the warning message display time is short, and there is a high possibility that the user will miss the warning message. Accordingly, by continuously displaying the warning message on the display 13 when the PC 1 is during the operating period, even if the user misses the warning message at the time of startup, the user can view the warning message when using the PC 1. Note that since continuously displaying the warning message on the display 13 when the PC 1 is during the operating period has the possibility of taking up a large amount of display area on the display 13 and reducing work efficiency, the warning message preferably is displayed in the corner of the display area on the display 13 or as a pop-up display by application software.

If the cumulative elapsed time C has reached the given time, control can be performed to prohibit start up of the BIOS 2 or the OS. If the cumulative elapsed time C has reached the given time, control can be performed to restrict or stop specified functions. In other words, if only the display of a warning message is performed, the PC 1 can be started up regardless of the fact that the cumulative elapsed time C has reached the given time. Starting up the PC 1 in this condition has the possibility of causing failures to worsen, such as causing further degradation of the hard disk. If the PC 1 is started up and the user starts working, there is the possibility of inconveniences such as the loss of data being worked on, due to operations becoming unstable during the work, or the power supply to the PC 1 suddenly being blocked. Accordingly, prohibiting or restricting work performed using the PC 1 if the cumulative elapsed time C has reached the given time can suppress inconveniences such as described above.

If the cumulative elapsed time C has reached the given time, control may be performed for display 13. For example, extinguishing the backlight of the display 13 (if the display 13 includes a backlight, such as a liquid crystal display), switching the display brightness of the display 13 to a low brightness, or intentionally causing the display of the display 13 to flash may be conducted.

If the cumulative elapsed time C has reached the given time, the functionality of the operation unit 16 (the keyboard, mouse, touchpad, or the like) may be stopped. In this way, controlling the display condition of the display 13 or stopping the functionality of the operation unit 16 enables the user to be alerted that the cumulative elapsed time C has reached the given time. In other words, willfully performing a display that obstructs work or disabling operations by the operation unit 16 prompts the user to stop using the PC 1. If the user stops using the PC 1, the further worsening of failures in the PC 1 can be suppressed.

If the PC 1 is started up and the user starts working regardless of the fact that the cumulative elapsed time C has reached the given time, there is the possibility of inconveniences such as the loss of data being worked on, due to operations becoming unstable during the work, or the power supply to the PC 1 suddenly being blocked. However, the above-described inconveniences can be suppressed if the use of the PC 1 by the user is stopped by the above-described display control or regulation of operations.

Note that the system timer 12 of the microcomputer 4 can be realized by a timer that has a limited timing period. For example, in the case of using a timer that only can count to 100 hours, the timing result can be added each time the system timer 12 counts up to 100 hours and written to the storage unit 9 of the BIOS 2, and the system timer 12 can be caused to start timing again from zero hours. This enables reducing the cost of the PC 1 since a microcomputer including a system timer that has a short timing period is inexpensive.

### 3. Effects of the Embodiment and Other Remarks

According to the information processing apparatus and elapsed time measuring method of the present embodiment, measuring is performed by different timing units that cannot be modified by an operation from the outside, depending on whether the PC 1 is during the operating condition or the non-operating condition, and the cumulative elapsed time from manufacturing is measured by adding together the timing results of the timing units, thereby enabling extremely accurately measuring the elapsed time.

In other words, the cumulative elapsed time is calculated in the calculation unit 8 with use of the elapsed time measured by the system timer 12 as the elapsed time for when the PC 1 is in the operating period, and with use of the elapsed time measured by the RTC 11 as the elapsed time for when the PC 1 is in the non-operating period. This enables calculating an extremely accurate elapsed time.

According to the information processing apparatus, since this structure can be realized by an existing hardware structure, an information processing apparatus including the elapsed time measuring function can be realized without a increase in cost.

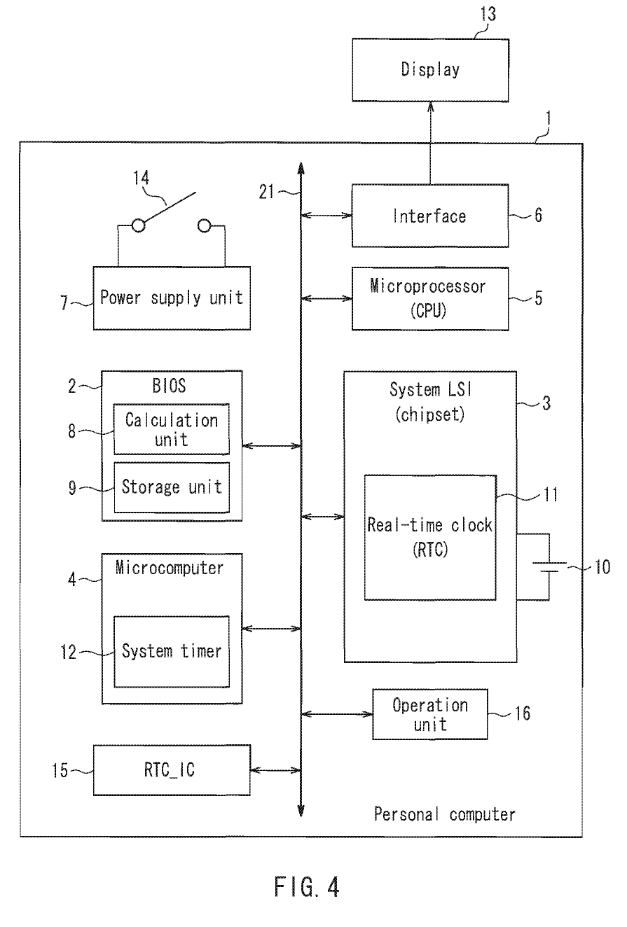

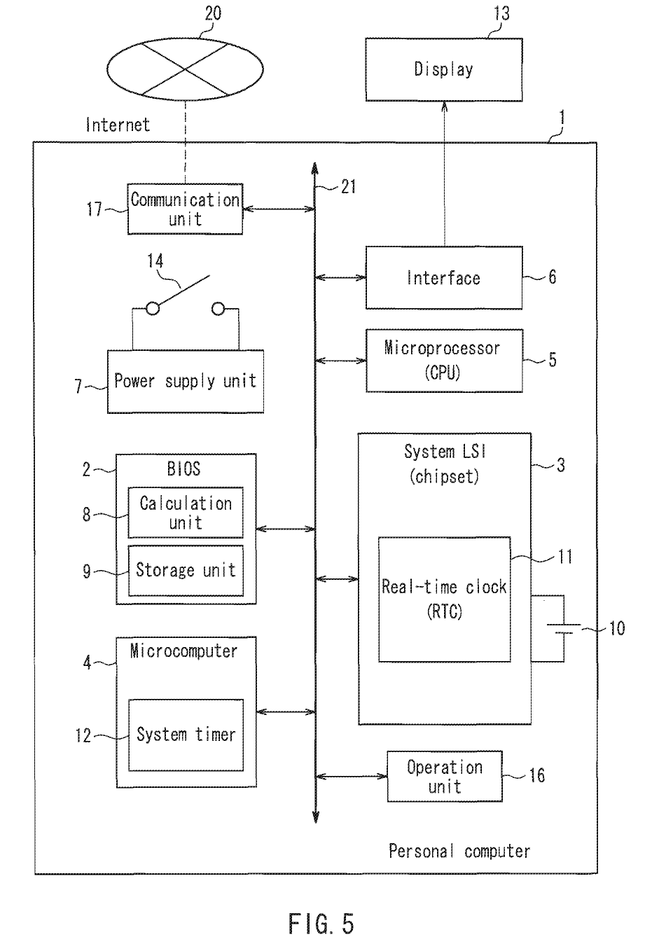

Note that instead of the structure shown in FIG. 1, an information processing apparatus able to measure the elapsed time of the apparatus can have the structures shown in FIG. 4 and FIG. 5. The information processing apparatuses shown in FIG. 4 and FIG. 5 can have a higher measuring precision than the information processing apparatus shown in FIG. 1.

The information processing apparatus shown in FIG. 4 is the same as the information processing apparatus shown in FIG. 1, with the addition of an RTC_IC 15 that is a dedicated RTC IC. The RTC_IC 15 can receive a constant power supply for operation due to the backup battery 10 and can measure the elapsed time since time T1 shown in FIG. 2 when the PC 1 is in the operating condition and the non-operating condition. As described above, there is a possibility of the time data output from the RTC 11 being changed by the user performing an operation from the outside. However, the time data output from the RTC_IC 15 cannot be changed by the user performing an operation from the outside, thereby enabling measuring an accurate elapsed time when the PC 1 is during both the operating period and the non-operating period.

The information processing apparatus shown in FIG. 5 is the same as the information processing apparatus shown in FIG. 1, with the addition of a communication unit 17. The communication unit 17 includes a communication circuit that performs processing for connecting to the Internet 20 and a communication port to which a communication cable can be connected or a wireless communication antenna. The information processing apparatus shown in FIG. 5 can be connected to the Internet 20 via the communication unit 17, and can obtain time information (the standard time) distributed from a standard time information distribution server. The calculation 8 measures the elapsed time from manufacturing of the apparatus by comparing the time information obtained from the standard time information distribution server via the Internet 20 and manufacturing date/time information stored in the storage unit 9 or the like in advance. In this way, the manufacturing date/time and standard time are compared to measure the elapsed time from manufacturing of the apparatus, thereby enabling calculating of an accurate elapsed time.

Note that a structure including both the RTC_IC 15 shown in FIG. 4 and the communication unit 17 is also possible. Alert processing such as displaying a warning may be performed when the cumulative elapsed time calculated by at least one of the above three elapsed time measuring methods (the measuring method using the RTC 11, the measuring method using the RTC_IC 15, and the measuring method using the Internet connection) has reached a given time (e.g., ten years) that has been set in advance. Also, alert processing such as displaying a warning may be performed when the cumulative elapsed time calculated by at least two of the above three elapsed time measuring methods has reached the given time. In this way, alert processing can be performed more reliably than in the case of an apparatus that can perform only one elapsed time measuring method.

Also, the measurement results of the three elapsed time measuring methods may be compared, and if two of the measurement results are values that are similar to each other and the remaining measurement result is significantly different from the other two measurement results, the remaining measurement result may be modified based on the two measurement results whose values are similar to each other. In other words, if measurement results are different from each other, the measurement results may be adjusted based on a majority.

Note that two of the three elapsed time measuring methods may be selected, instead of using all three elapsed time measuring methods.

Although a case of using a PC has been described in the above embodiment, the elapsed time measuring method of the present invention can be applied to various electronic devices that have at least a timing function, such as a television receiver, a mobile phone terminal, a PDA (Personal Digital Assistant), and a portable gaming device.

In addition to the various types of control performed to issue a warming when the given elapsed time has been reached, the elapsed time since manufacturing may be displayed on the display etc. as needed.

Although the present embodiment describes a configuration in which a crystal oscillator is provided in the RTC 11 and timing is performed based on the clock generated by the crystal oscillator, the present invention is not limited to including a crystal oscillator as long as at least a clock that enables performing timing is generated. For example, the generation of such a clock can be realized by an R-C oscillation circuit in which resistors and capacitors are connected in parallel, an L-C oscillation circuit in which coils and capacitors are connected in parallel, a ceramic oscillator, or the like. An R-C oscillation circuit is a circuit in which only resistors and capacitors are connected in parallel, thereby enabling low-costs as well as advantages of size-reduction due to having few parts. Similarly, an L-C oscillation circuit is a circuit in which only coils and capacitors are connected in parallel, thereby enabling low-costs as well as advantages of size-reduction due to having few parts. A ceramic oscillator is an element in which a voltage is applied to a piezoelectric ceramic to cause the ceramic to mechanically resonate, thereby obtaining a clock having a specific frequency (in the present embodiment, 1 Hz). A ceramic oscillator is lower in cost than a crystal oscillator and is higher in precision than R-C oscillation circuits and L-C oscillation circuits.

Although the PC 1 has various power supply conditions such as suspend mode, standby mode, and hibernation condition, the “operating condition” and “non-operating condition” in the present embodiment can be distinguished according to at least the ON/OFF condition of the microcomputer 4.

Although the timing result output by the system timer 12, the operation end times of the PC 1, the operation start times of the PC 1, and the timing result output by the RTC 11 are stored in the storage unit 9 of the BIOS 2 in the present embodiment, such information may be stored in a storage area in the microcomputer 4. However, since the storage area of the microcomputer 4 is reset when the PC 1 is powered off, there is a need to connect the microcomputer 4 to a backup battery to provide a constant power supply. Such a structure enables reducing the storage capacity of the storage unit 9 in the BIOS 2, thereby achieving a reduction in cost.

Although the timing result output by the system timer 12, the operating end times of the PC 1, the operating start times of the PC 1, and the timing result output by the RTC 11 are stored in the storage unit 9 of the BIOS 2 in the present embodiment, such information may be stored in a hard disk drive (HDD) or silicon disk drive (SDD) that is included in the PC 1 or externally connected to the PC 1. Such a structure enables reducing the storage capacity of the storage unit 9 in the BIOS 2, thereby achieving a reduction in cost. Also, since HDDs and SDDs have much higher storage capacities than the storage unit 9 in the BIOS 2, the timing results and time information can be stored substantially reliably even if they become large amounts of information.

The microcomputer 4 and the system timer 12 included therein according to the present embodiment are examples of a main timing unit of the present invention. The RTC 11 according to the present embodiment is an example of an sub timing unit of the present invention. The BIOS 2 and the calculation unit 8 included therein according to the present embodiment are examples of a calculation unit of the present invention. The microprocessor 5 according to the present embodiment is an example of an alert unit of the present invention.

The information processing apparatus and elapsed time measuring method of the present invention can accurately detect the elapsed time of a product without being influenced by a user operation, which is advantageous to performing control in a case where a given time has been reached and as a means for confirming how much time has passed in the product.

The invention may be embodied in other forms without departing from the spirit or essential characteristics thereof. The embodiment disclosed in this application is to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An information processing apparatus comprising:
a main timing unit able to measure an elapsed time in an operating period of the apparatus;
a sub timing unit able to measure an elapsed time in at least a non-operating period of the apparatus; and
a calculation unit that adds together the elapsed time measured by the main timing unit and the elapsed time measured by the sub timing unit,
wherein the calculation unit adds together each elapsed time measured by the main timing unit when the apparatus is in the operating period, adds together each elapsed time measured by the sub timing unit when the apparatus is during the non-operating period, and calculates a cumulative elapsed time from a given date/time based on the added elapsed times.

2. The information processing apparatus of claim 1,
wherein the calculation unit obtains operation end time information pertaining to the apparatus from the sub timing unit, obtains operation start time information pertaining to the apparatus from the sub timing unit, and calculates non-operating time information based on a difference between the operation end time information and the operation start time information, and
the calculation unit calculates the cumulative elapsed time from the given date/time by adding together operating time information pertaining to the apparatus that has been output from the main timing unit and the non-operating time information.

3. The information processing apparatus of claim 2,
wherein the calculation unit compares the cumulative elapsed time and a given time that has been set in advance, and
alert processing is performed if a result of the comparison is that the cumulative elapsed time has exceeded the given time.

4. An information processing apparatus comprising:
a microcomputer able to measure an elapsed time in an operating period of the apparatus;
a system LSI including a real-time clock able to measure an elapsed time in at least a non-operating period of the apparatus; and
a BIOS that adds together the elapsed time measured by the microcomputer and the elapsed time measured by the real-time clock,
wherein the BIOS adds together each elapsed time measured by the microcomputer when the apparatus is in the operating period, adds together each elapsed time measured by the real-time clock when the apparatus is in the non-operating period, and calculates a cumulative elapsed time from a given date/time based on the added elapsed times.

5. An elapsed time measuring method comprising:
a main timing step of measuring an elapsed time in an operating period of an information processing apparatus;
an auxiliary timing step of measuring an elapsed time in at least a non-operating period of the information processing apparatus; and
a calculating step of adding together the elapsed time measured in the main timing step and the elapsed time measured in the auxiliary timing step,
wherein operating time information that is an elapsed time from a start of operation to an end of operation is obtained in the main timing step,
operation end time information is obtained in the auxiliary timing step when operation of the information processing apparatus ends,
operation start time information is obtained in the auxiliary timing step when operation of the information processing apparatus starts,
non-operating time information is generated based on a difference between the operation start time information and the operation end time information, and
a cumulative elapsed time from a given date/time is calculated by adding together the operating time information and the non-operating time information.

6. The elapsed time measuring method of claim 5,
wherein the cumulative elapsed time and a given time that has been set in advance are compared, and
alert processing is performed if a result of the comparison is that the cumulative elapsed time has exceeded the given time.
